(19) United States
(12) Patent Application Publication
(10) Pub. No.: US 2025/0267710 A1
(43) Pub. Date: Aug. 21, 2025

(54) DETERMINING PHYSICAL RANDOM ACCESS CHANNEL (PRACH) OCCASIONS FOR PRACH TRANSMISSIONS

(71) Applicant: SHARP KABUSHIKI KAISHA, Sakai City (JP)

(72) Inventors: Tomoki Yoshimura, Camas, WA (US); Zhanping Yin, Vancouver, WA (US)

(21) Appl. No.: 18/443,084

(22) Filed: Feb. 15, 2024

(51) Int. Cl. H04W 74/0833

(52) U.S. Cl. CPC H04W 74/0833

(57) ABSTRACT

A user equipment (UE) that includes one or more non-transitory computer-readable media that stores computer-executable instructions for transmitting a Physical Random Access Channel (PRACH) and a processor is provided. The processor is configured to receive a first PRACH resource configuration indicating one or more first uplink (UL) resources for a PRACH transmission. The processor is configured to receive a second PRACH resource configuration indicating one or more second UL resources for the PRACH transmission and determine whether to select the first or second PRACH resource configuration based on a criteria. The processor configures one or more PRACH occasions associated with the first UL resources when the first PRACH resource configuration is selected. The processor configures one or more PRACH occasions associated with the second UL resources when the second PRACH resource configuration is selected. The processor is configured to transmit the PRACH using the one or more PRACH occasions.

### TECHNICAL FIELD

The technology generally relates to wireless communications, and more particularly, to determining one or more Physical Random Access Channel (PRACH) occasions for a PRACH transmission.

### BACKGROUND

With the tremendous growth in the number of connected devices and the rapid increase in user/network (NW) traffic volume, various efforts have been made to improve different aspects of wireless communication for next-generation radio communication systems, such as fifth-generation (5G) New Radio (NR), by improving data rate, latency, reliability, and mobility.

The 5G NR system is designed to provide flexibility and configurability to optimize NW services and types, thus accommodating various use cases, such as enhanced Mobile Broadband (eMBB), massive Machine-Type Communication (mMTC), and Ultra-Reliable and Low-Latency Communication (URLLC).

However, as the demand for radio access continues to increase, there is a need for further improvements in wireless communications in the next-generation radio communication systems.

### SUMMARY

In a first aspect of the present application, a user equipment (UE) is provided. The UE includes one or more non-transitory computer-readable media storing one or more computer-executable instructions for transmitting a PRACH and at least one processor coupled to the one or more non-transitory computer-readable media. The at least one processor is configured to execute the one or more computer-executable instructions to cause the UE to receive a first PRACH resource configuration that indicates a first set of uplink (UL) resources for a PRACH transmission; receive a second PRACH resource configuration that indicates a second set of UL resources for the PRACH transmission; determine whether to select the first PRACH resource configuration or the second PRACH resource configuration based on a criteria; configure one or more PRACH occasions associated with the first set of UL resources in a case that the first PRACH resource configuration is selected; configure one or more PRACH occasions associated with the second set of UL resources in a case that the second PRACH resource configuration is selected; and transmit the PRACH using the one or more PRACH occasions.

In an implementation of the first aspect, the first set of UL resources includes one or more non-SubBand Full Duplex (non-SBFD) UL resources, and the second set of UL resources includes one or more SBFD UL resources

In another implementation of the first aspect, the at least one processor is further configured to execute the one or more computer-executable instructions to cause the UE to measure a reception quality value by the UE. Determining whether to select the first PRACH resource configuration or the second PRACH configuration based on a criteria includes selecting the first PRACH resource configuration in a case that the reception quality value is above a threshold; selecting the second PRACH resource configuration in a case that the reception quality value is below the threshold; and selecting either one of the first and second PRACH resource configurations in a case that the reception quality value is equal to the threshold.

In another implementation of the first aspect, the reception quality value is a Reference Signal Reception Power (RSRP) of a synchronization signal/physical broadcast channel (SS/PBCH) block currently monitored by the UE.

In another implementation of the first aspect, the at least one processor is further configured to execute the one or more computer-executable instructions to cause the UE to receive the threshold from the BS as an RRC parameter.

In another implementation of the first aspect, the at least one processor is further configured to execute the one or more computer-executable instructions to cause the UE to receive one or more RRC parameters from the BS in an RRC message. Determining whether to select the first PRACH resource configuration or the second PRACH configuration based on a criteria includes determining the PRACH resource configuration based on the RRC parameters.

In another implementation of the first aspect, the one or more RRC parameters are included by the BS in an RRC layer information element RACH-ConfigCommon.

In another implementation of the first aspect, the RRC parameters include one or more of information regarding a format of the PRACH, information regarding time domain resources of the PRACH, information regarding frequency domain resources of the PRACH, or information regarding a number of random-access preambles available for random-access per each PRACH occasion.

In another implementation of the first aspect, the at least one processor is further configured to execute the one or more computer-executable instructions to cause the UE to determine one or more of a length of the PRACH, a number of subcarriers for the PRACH, and a number of sequence repetitions in the PRACH based on the information regarding the format of the PRACH.

In another implementation of the first aspect, the at least one processor is further configured to execute the one or more computer-executable instructions to cause the UE to receive a downlink control information (DCI) from the BS. Determining whether to select the first PRACH resource configuration or the second PRACH configuration based on a criteria includes selecting the PRACH resource configurations based on a PRACH resource configuration instruction included in the DCI.

In another implementation of the first aspect, the DCI further includes a PRACH occasion instruction. The at least one processor is further configured to execute the one or more computer-executable instructions to cause the UE to validate several PRACH occasions; and select a PRACH occasion from the several PRACH occasions to transmit the PRACH.

In another implementation of the first aspect, the DCI further includes a random-access preamble instruction. The at least one processor is further configured to execute the one or more computer-executable instructions to cause the UE to select a random-access preamble from several of random-access preambles available for the PRACH in the selected PRACH occasion.

In another implementation of the first aspect, selecting one of a first or second PRACH resource configurations based on a criteria includes determining whether a Contention-Free Random-Access (CFRA) procedure is used by the BS; and selecting the second PRACH resource configuration in a case that the CFRA procedure is used.

In another implementation of the first aspect, the UE is a SBFD aware UE, the first PRACH resource configuration is shared by SBFD aware UEs and non-SBFD aware UEs, and the second PRACH resource configuration is not available to the non-SBFD aware UEs.

In a second aspect, a method of transmitting a PRACH is provided. The method includes receiving a first PRACH resource configuration that indicates a first set of UL resources for a PRACH transmission; receiving a second PRACH resource configuration that indicates a second set of UL resources for the PRACH transmission; determining whether to select the first PRACH resource configuration or the second PRACH resource configuration based on a criteria; configuring one or more PRACH occasions associated with the first set of UL resources in a case that the first PRACH resource configuration is selected; configuring one or more PRACH occasions associated with the second set of UL resources in a case that the second PRACH resource configuration is selected; and transmitting the PRACH using the one or more PRACH occasions.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a schematic diagram illustrating a radio communication system, according to an example implementation of the present disclosure.

FIGS. 2A and 2B are two diagrams illustrating parameters related to subcarrier spacing (SCS)-specific carriers, according to an example implementation of the present disclosure.

FIG. 3 is a diagram illustrating an example configuration of SCS-specific carriers, according to an example implementation of the present disclosure.

FIG. 4 is a diagrammatic view illustrating an example configuration of a resource grid, according to an example implementation and mode of the present disclosure.

FIG. 5 is a schematic block diagram illustrating a configuration example of a base station device, according to an example implementation of the present disclosure.

FIG. 6 is a schematic block diagram illustrating a configuration example of a terminal device, according to an example implementation of the present disclosure.

FIG. 7 is a diagram illustrating an example configuration of a synchronization signal/physical broadcast channel block including a primary synchronization signal and a secondary synchronization signal, according to an example implementation of the present disclosure.

FIG. 8 is a time-frequency diagram illustrating an example resource partitioning in a serving cell, according to an example implementation of the present disclosure.

FIG. 9 is a diagram illustrating an example SubBand Full Duplex configuration in frequency domain, according to an aspect of the present embodiment.

FIG. 10 is a flowchart illustrating an example method/process performed by a terminal device to determine the transport block size, according to an example implementation of the present disclosure.

FIG. 11 is a time-frequency diagram illustrating an example configuration of the PRACH occasions, according to an aspect of the present embodiment.

FIG. 12 is a flowchart illustrating an example method/process performed by a terminal device to transmit a PRACH, according to an example implementation of the present disclosure.

FIGS. 13A-13B illustrate a flowchart of an example method/process performed by a terminal device to select a PRACH resource configuration based on a criteria, according to an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not shown) by the same numerals in the example figures. However, the features in different implementations may differ in other respects, and thus may not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent. In addition, the terms “system” and “network” herein may be used interchangeably.

As used herein, the term “and/of” should be interpreted to mean one or more items. For example, the phrase “A, B, and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B, and C” or the phrase “at least one of A, B, or C” should be interpreted to mean any of: only A, only B, only C, A, and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

Additionally, for the purposes of explanation and non-limitation, specific details, such as functional entities, techniques, protocols, standard, and the like are set forth for providing an understanding of the described technology. In other examples, detailed descriptions of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software, or a combination of software and hardware. Described functions or algorithms may correspond to modules which may be software, hardware, firmware, or any combination thereof. The software implementation may include computer executable instructions stored on a computer-readable medium, such as a memory or other types of storage devices. For example, one or more microprocessors or general-purpose computers with communication processing capability may be programmed with corresponding executable instructions and carry out the described network function(s) or algorithm(s). The microprocessors or general-purpose computers may include of one or more Application-Specific Integrated Circuits (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer-readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long Term Evolution (LTE) system, an LTE-Advanced (LTE-A) system, an LTE-Advanced Pro system, or a 5G NR Radio Access Network (RAN)) typically includes at least one base station, at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a radio communication network established by one or more base stations.

It should be noted that, in the present application, a UE (or a terminal device) may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A base station (BS) may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, evolved LTE (eLTE), for example, LTE connected to 5GC, NR (often referred to as 5G), and/or LTE-A Pro. However, the scope of the present application should not be limited to the above-mentioned protocols.

A base station may include, but is not limited to, a node B (NB) as in the UMTS, an evolved node B (eNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), and any other apparatus capable of controlling radio communication and managing radio resources within a cell. The BS may connect to serve the one or more UEs through a radio interface to the network.

The BS may be operable to provide radio coverage to a specific geographical area using several cells included in the radio communication network. The BS may support the operations of the cells. Each cell may be operable to provide services to at least one UE within its radio coverage. Specifically, each cell (often referred to as a serving cell) may provide services to serve one or more UEs within its radio coverage (e.g., each cell may correspond to the Downlink (DL) and optionally Uplink (UL) resources to at least one UE within its radio coverage for DL and optionally UL packet transmission). The BS may communicate with one or more UEs in the radio communication system through the cells.

A cell may correspond to sidelink (SL) resources for supporting Proximity Service (ProSe) or Vehicle to Everything (V2X) services. Each cell may have overlapped coverage areas with other cells.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in 3GPP may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it should also be noted that in a transmission time interval of a single NR frame, DL transmission period, a guard period, and UL transmission data may at least be included, where the respective portions of the DL transmission data, the guard period, and the UL transmission data should also be configurable, for example, based on the network dynamics of NR. In addition, sidelink resources may also be provided in an NR frame to support ProSe services, (E-UTRA/NR) sidelink services, or (E-UTRA/NR) V2X services.

A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG may be a set of one or more serving cells including the PCell and zero or more secondary cells. Conversely, the SCG may be a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the DC mode, the PCell may belong to the MN. The Primary SCG Cell (PSCell) may be an SCG cell in which the UE performs random access (e.g., when performing the reconfiguration with a sync procedure). In Multi-RAT Dual Connectivity (MR-DC), the PSCell may belong to the SN. A Special Cell (SpCell) may be referred to a PCell of the MCG, or a PSCell of the SCG, depending on whether the Medium Access Control (MAC) entity is associated with the MCG or the SCG. Otherwise, the term Special Cell may refer to the PCell. A Special Cell may support a Physical Uplink Control Channel (PUCCH) transmission and contention-based Random Access, and may always be activated. Additionally, for a UE in an RRC_CONNECTED state that is not configured with the carrier aggregation/dual connectivity (CA/DC), may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

Some mathematical expressions used in the present application are provided below.

Floor (CX) represents a floor function for the real number CX. For example, floor (CX) may represent a function that provides the largest integer within a range that does not exceed the real number CX.

Ceil (DX) represents a ceiling function to a real number DX. For example, ceil (DX) may be a function that provides the smallest integer within the range not less than the real number DX.

Mod (EX, FX) represents a function that provides the remainder obtained by dividing EX by FX.

Exp (GX) represents e \hat{ } GX. Here, e is the Napier number. Also, (HX) \hat{ } (IX) indicates IX to the power of HX.

According to one aspect of the present embodiment, a waveform formed based on the OFDM may be used in a radio communication system. An OFDM symbol defines a unit in the time domain of the waveform. Each OFDM symbol is converted to a time-continuous signal during a baseband signal generation. For example, the cyclic prefix-OFDM (CP-OFDM) may be used in the downlink transmission of the radio communication system. For example, either CP-OFDM or Discrete Fourier Transform-spread-Orthogonal Frequency Division Multiplex (DFT-s-OFDM) may be used in the uplink transmission of the radio communication system.

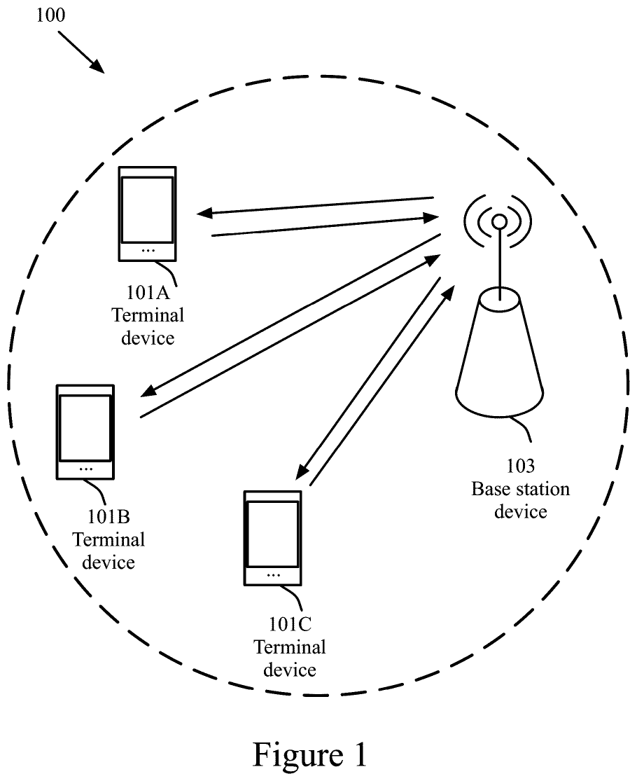

FIG. 1 is a schematic diagram illustrating a radio communication system, according to an example implementation of the present disclosure. In FIG. 1, the radio communication system 100 includes the terminal devices 101A to 101C and the base station device 103 (BS 103). The terms base station device, base station, and BS herein may be used interchangeably. The terms terminal device, user equipment, and UE herein may be used interchangeably.

The BS 103 may include one or more transmission/reception devices. When BS 103 is configured of multiple transmission/reception devices, each of the multiple transmission/reception devices may be arranged at a different position. A transmission/reception device may include a transmission device and/or a reception device.

The BS 103 may serve radio communication and provide one or more cells. A cell is defined as a set of resources used for a wireless communication. A cell may include one or both of a downlink component carrier and an uplink component carrier. A serving cell may include a downlink component carrier and two or more uplink component carriers.

One or more SubCarrier Spacing-specific (SCS-specific) carriers may be associated with one component carrier. Each SCS-specific carrier defines a carrier for a subcarrier-spacing configuration. For example, one SCS-specific carrier may be associated with either a downlink component carrier or an uplink component carrier. In another example, one SCS-specific carrier may be associated with both a downlink component carrier and an uplink component carrier.

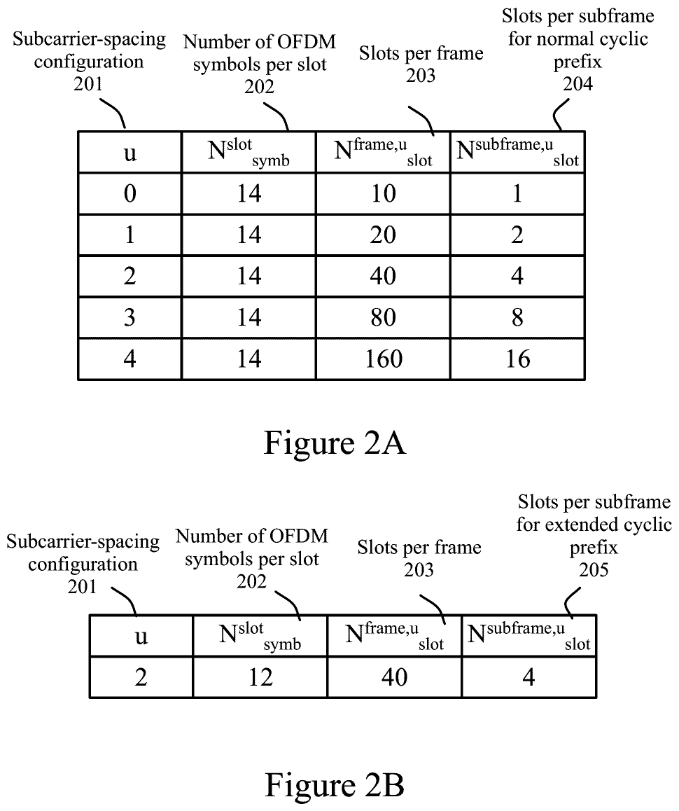

FIGS. 2A and 2B are two diagrams illustrating parameters related to SCS-specific carriers, according to an example implementation of the present disclosure. In FIGS. 2A and 2B, u 201 represents the subcarrier-spacing configuration. N^{slot}_{symb} 202 represents the number of OFDM symbols in a slot. N^{frame, u}ₛₗₒₜ 203 represents the number of slots in a radio frame. N^{subframe, u}ₛₗₒₜ 204 and N^{subframe, u}ₛₗₒₜ 205 represent the number of slots in a subframe for normal cyclic prefix and extended cyclic prefix, respectively.

In FIG. 2A, for example, when the subcarrier-spacing configuration u 201 is set to 2 and the CP configuration is set to normal Cyclic Prefix CP), the parameters are set to N^{slot}_{symb}=14, N^{frame, u}ₛₗₒₜ=40, and N^{subframe, u}ₛₗₒₜ=4. Further, in FIG. 2B, for example, when the subcarrier-spacing configuration u 201 is set to 2 and the CP configuration is set to an extended CP, the parameters are set to N^{slot}_{symb}=12, N^{frame, u}ₛₗₒₜ=40, N^{subframe, u}ₛₗₒₜ=4.

The Time unit T_{c} represents the length of the time domain. The time unit T_{c} may be calculated by 1/(dfₘₐₓ*N_{f}), where dfₘₐₓ represents 480 kHz and N_{f}=4096. The constant k may be calculated by dfₘₐₓ*N_{f}/(df_{ref}N_{f, ref}). The constant k is 64 when df_{ref} is 15 kHz and N_{f, ref} is 2048.

Radio transmissions in the downlink and/or radio transmissions in the uplink may be organized into radio frames (or system frames, frames) of length T_{f}. T_{f} is calculated by (dfₘₐₓN_{f}/100)*Tₛ and (dfₘₐₓN_{f}/100)*Tₛ is equal to 10 ms. One radio frame may include ten subframes. The subframe length T_{sf} is calculated by dfₘₐₓN_{f}Tₛ/1000 and dfₘₐₓN_{f}Tₛ/1000 is equal to 1 ms. The number of OFDM symbols per subframe N^{subframe, u}_{symb} is calculated by N^{slot}_{symb}N^{subframe, u}ₛₗₒₜ.

The SCS of the OFDM-based waveform may be calculated by subcarrier-spacing configuration u. For example, the SCS may be calculated by 15000*2^{u}.

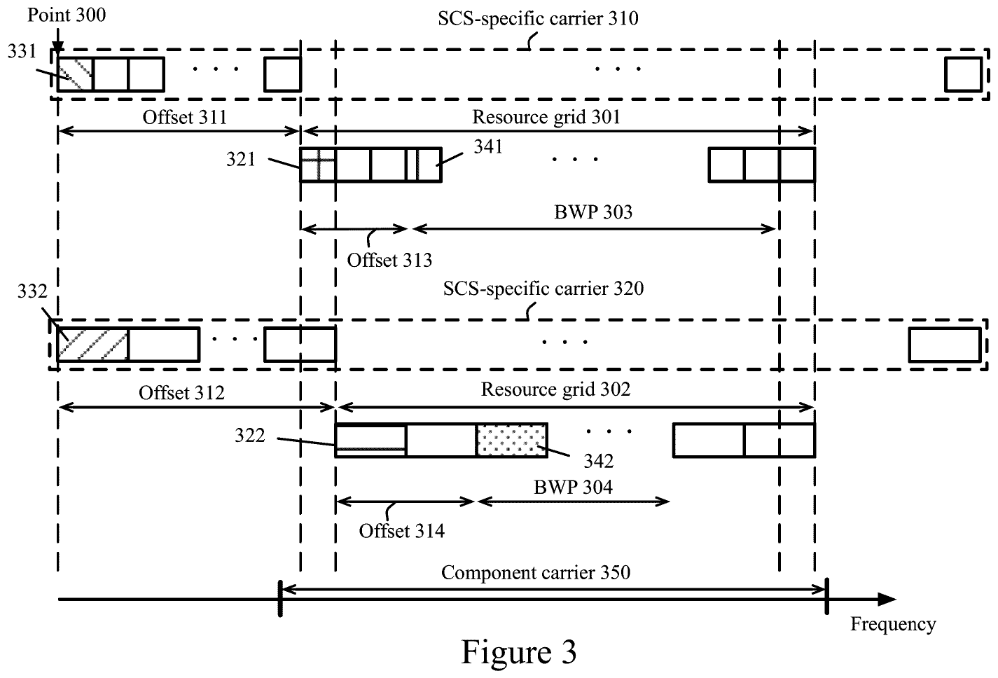

FIG. 3 is a diagram illustrating an example configuration of SCS-specific carriers, according to an example implementation of the present disclosure. The horizontal axis in FIG. 3 represents the frequency domain. FIG. 3 shows a configuration example of two SCS-specific carriers associated with the component carrier 350. In FIG. 3, u₁=u₂−1 is assumed.

Point 300 is an identifier for a specific subcarrier. Point 300 is also referred to as Point A. Common resource blocks (CRBs) for SCS-specific carrier 310 are defined with respect to Point 300. The CRB with index 0 is represented by the block 331. CRBs for SCS-specific carrier 320 are defined with respect to Point 300. The CRB with index 0 is represented by the block 332. The CRB with index 0 is defined as the CRB where a subcarrier in the CRB coincides with the subcarrier identified by Point 300.

In FIG. 3, the bandwidth of one CRB in the SCS-specific carrier 310 is a half bandwidth of one CRB in the SCS-specific carrier 320. In other implementations, the bandwidth of one CRB in the SCS-specific carrier 310 may be the same as the bandwidth of one CRB in the SCS-specific carrier 320.

The offset 311 is a Resource Block-level (RB-level) offset from the CRB with index 0 for SCS-specific carrier 310 to the reference point 321 of the resource grid 301. The reference point of the resource grid 301 is the block 321. The offset 312 is an RB-level offset from the CRB with index 0 for SCS-specific carrier 320 to the reference point 322 of the resource grid 302. The reference point of the resource grid 302 is the block 322.

The offset 313 is an RB-level offset from the reference point 321 of the resource grid 301 to the reference point 341 of the Band Width Part (BWP) 303. The reference point of the BWP 303 is the block 341. The offset 314 is an RB-level offset from the reference point 322 of the resource grid 301 to the reference point 342 of the BWP 304. The reference point of the BWP 304 is the block 342.

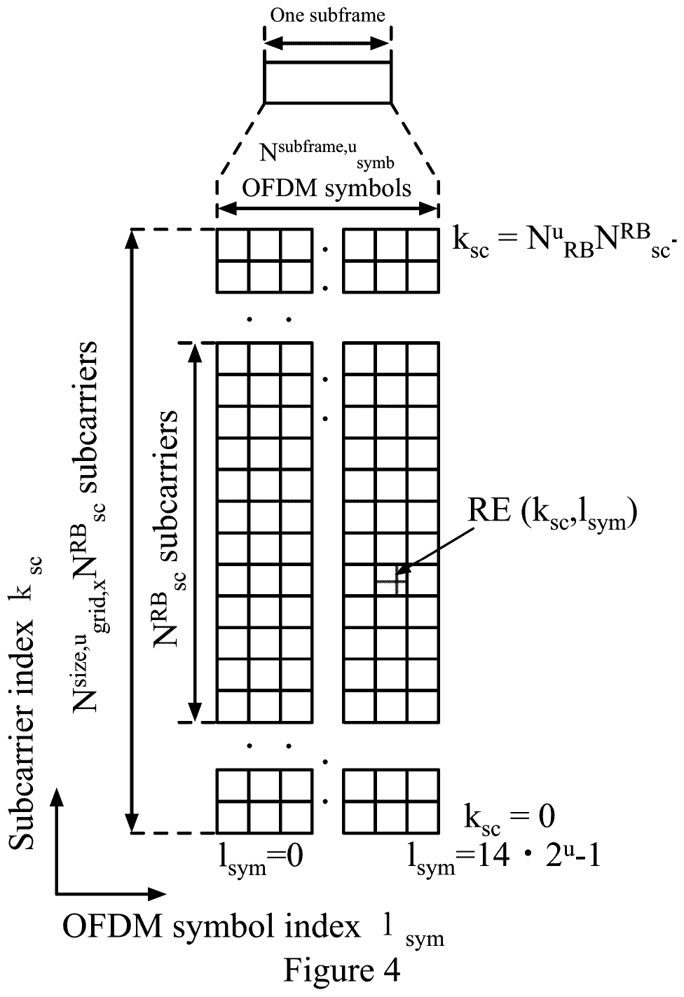

FIG. 4 is a diagrammatic view illustrating an example configuration of a resource grid, according to an example implementation and mode of the present disclosure. The horizontal axis represents OFDM symbol index l_{sym}. The vertical axis represents the subcarrier index k_{sc}. The resource grid includes N^{size,u}_{grid,x}N^{RB}_{sc} subcarriers and N^{subframes,u}_{symb} OFDM symbols. A resource specified by the subcarrier index k_{sc} and the OFDM symbol index l_{sym} in a resource grid is also referred to as (Resource Element (RE).

A resource block (RB) includes N^{RB}_{sc} consecutive subcarriers. A resource block is a generic name for a CRB, a Physical Resource Block (PRB), and/or a Virtual Resource Block (VRB). In FIG. 4, N^{RB}_{sc} may be 12. CRBs are indexed in ascending order starting at CRB with index 0. PRBs are indexed in ascending order starting at its reference point of the BWP. A BWP is defined as a subset of resource blocks included in the resource grid. The BWP includes N^{size, u}_{BWP,i} resource blocks starting from the reference points of the BWP.

An antenna port may be defined such that the channel over which a symbol on the antenna port is conveyed may be inferred from the channel over which another symbol on the same antenna port is conveyed. The channel may correspond to a physical channel. The symbols may correspond to OFDM symbols. The symbols may correspond to resource block units. The symbols may correspond to resource elements.

Two antenna ports are said to be Quasi Co-Located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Carrier aggregation is a framework of communication using multiple aggregated serving cells or using multiple component carriers.

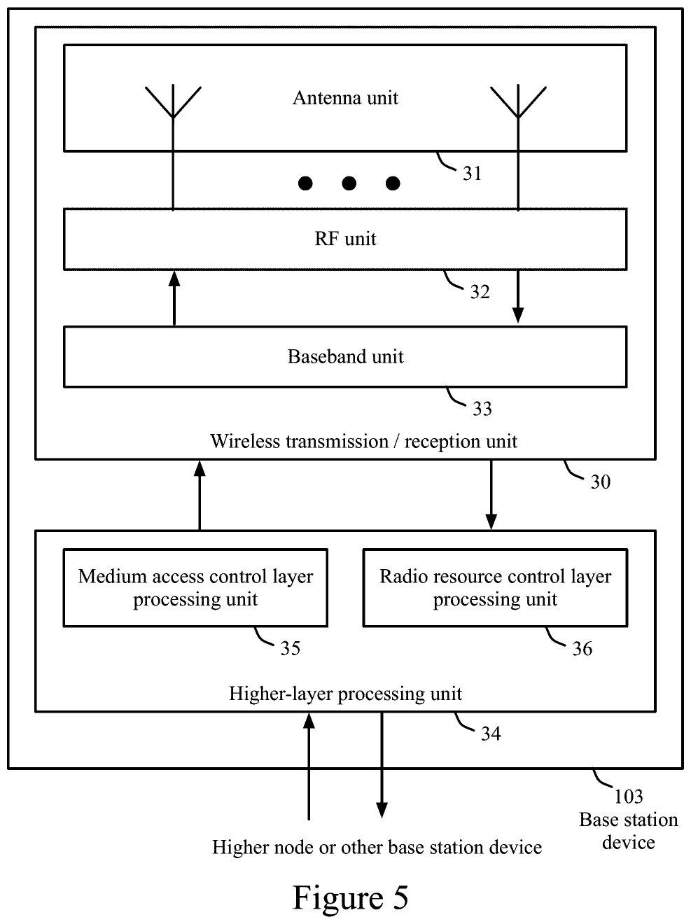

FIG. 5 is a schematic block diagram illustrating a configuration example of a base station device 103, according to an example implementation of the present disclosure. As shown in FIG. 5, the base station device 103 may include a part or all of the wireless transmission and reception unit (also referred to herein as physical layer processing unit) 30 and a higher-layer processing unit 34. The wireless transmission and reception unit 30 may include a part or all of an antenna unit 31, a Radio Frequency (RF) unit 32, and a baseband unit 33. The higher-layer processing unit 34 may include a part or all of a Medium Access Control (MAC) layer processing unit 35 and a Radio Resource Control (RRC) layer processing unit 36.

The wireless transmission and reception unit 30 may include a part (or all) of a wireless transmission unit 30a (not shown in the figure) and a wireless reception unit 30b (not shown in the figure). The configuration of the baseband unit 33 in the wireless transmission unit 30a and the configuration of the baseband unit 33 in the wireless reception unit 30b may be the same or different. The configuration of the RF unit 32 in the wireless transmission unit 30a and the configuration of the RF unit 32 in the wireless reception unit 30b may be the same or different. The configuration of the antenna unit 31 in the wireless transmission unit 30a and the configuration of the antenna unit 31 in the wireless reception unit 30b may be the same or different. The wireless transmission and reception unit 30 may include at least one processor (not shown in the figure) and one or more non-transitory computer-readable media (not shown in the figure) that store computer-executable instructions and data.

The higher-layer processing unit 34 may provide downlink data (e.g., transport blocks) to the wireless transmission and reception unit 30 (or the wireless transmission unit 30a). The higher-layer processing unit 34 may perform the processing of a part or all of the MAC layer, the Packet Data Convergence Protocol (PDCP) layer, the Radio Link Control (RLC) layer and the RRC layer. The higher-layer processing unit 34 may also include at least one processor (not shown in the figure) and one or more non-transitory computer-readable media (not shown in the figure) that store computer-executable instructions and data.

The MAC layer processing unit 35 may perform the processing of the MAC layer. The RRC layer processing unit 36 may perform the processing of the RRC layer. The RRC layer processing unit 36 may manage various RRC parameters of the terminal device 101.

The wireless transmission and reception unit 30 (or the wireless transmission unit 30a) may perform processing, such as encoding and modulation. The wireless transmission and reception unit 30 (or the wireless transmission unit 30a) generates a physical signal by encoding and modulating the downlink data. The wireless transmission and reception unit 30 (or the wireless transmission unit 30a) converts the OFDM symbols in the physical signal to a baseband signal by converting them to a time-continuous signal. The wireless transmission and reception unit 30 (or the wireless transmission unit 30a) transmits the baseband signal (or the physical signal) to the terminal device 101 via radio frequency. The wireless transmission and reception unit 30 (or the wireless transmission unit 30a) may arrange the baseband signal (or the physical signal) on a component carrier and transmit the baseband signal (or the physical signal) to the terminal device 101.

The wireless transmission and reception unit 30 (or the wireless reception unit 30b) may perform processing, such as demodulation and decoding. The wireless transmission and reception unit 30 (or the wireless reception unit 30b) separates, demodulates, and decodes the received physical signal, and provides the decoded information to the higher-layer processing unit 34. The wireless transmission and reception unit 30 (or the wireless reception unit 30b) may perform the channel access procedure prior to the transmission of the physical signal.

The RF unit 32 demodulates the radio signal received via the antenna unit 31 into an analog signal, and/or removes the extra frequency components. The RF unit 32 provides the processed analog signal to the baseband unit 33.

The baseband unit 33 converts the analog signal input from the RF unit 32 into a baseband signal. The baseband unit 33 separates a portion which corresponds to the CP from the baseband signal. The baseband unit 33 performs Fast Fourier Transformation (FFT) on the baseband signal from which the CP has been removed. The baseband unit 33 extracts components of the physical signal from the baseband signal. The baseband unit 33 performs Inverse Fast Fourier Transformation (IFFT) on the downlink data to generate time-continuous signal, adds a CP to the generated signal, generates a baseband signal, and converts the baseband signal into an analog signal. The baseband unit 33 provides the analog signal to the RF unit 32.

The RF unit 32 removes the extra frequency components from the analog signal input from the baseband unit 33, up-converts the analog signal to a radio frequency, and transmits it via the antenna unit 31. The RF unit 32 may have the function of controlling transmission power.

The terminal device 101 may configure one or more downlink BWPs per serving cell. The terminal device 101 may configure one or more uplink BWPs per serving cell.

The terminal device 101 may try to detect a Physical Downlink Shared Channel (PDSCH), a Physical Downlink Control Channel (PDCCH), and a Channel State Information-Reference Signal (CSI-RS) in the active downlink BWP. The terminal device 101 may transmit a Physical Uplink Control Channel (PUCCH) and a Physical Uplink Shared Channel (PUSCH) in the active uplink BWP. The active downlink BWP and the active uplink BWP are also referred to as active BWP.

The terminal device 101 may not receive the PDSCH, PDCCH, and CSI-RS in the downlink BWPs other than the active downlink BWP. The terminal device 101 may not transmit the PUCCH and PUSCH in the uplink BWPs other than the active uplink BWP. BWPs other than the active BWP is referred to as inactive BWPs.

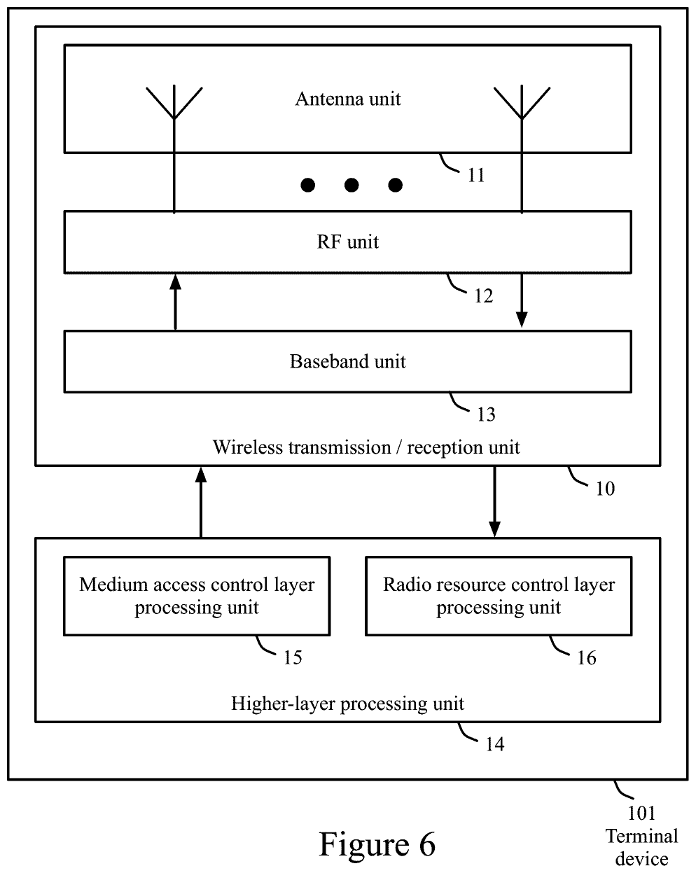

FIG. 6 is a schematic block diagram illustrating a configuration example of a terminal device 101, according to an example implementation of the present disclosure. The terminal device 101 may be any of the terminal devices 101A-101C, shown in FIG. 1. As shown in FIG. 6, the terminal device 101 may include a part or all of the wireless transmission and reception unit (also referred to herein as physical layer processing unit) 10 and the higher-layer processing unit 14. The wireless transmission and reception unit 10 may include a part or all of the antenna unit 11, the RF unit 12, and the Baseband unit 13. The higher-layer processing unit 14 may include a part or all of the MAC layer processing unit 15 and the RRC layer processing unit 16. The higher-layer processing unit 14 may include at least one processor (not shown in the figure) and one or more non-transitory computer-readable media (not shown in the figure) that store computer-executable instructions and data.

The wireless transmission and reception unit 10 may include a part of or all of the wireless transmission unit 10a (not shown in the figure) and the wireless reception unit 10b (not shown in the figure). The wireless transmission and reception unit 10 may include at least one processor (not shown in the figure) and one or more non-transitory computer-readable media (not shown in the figure) that store computer-executable instructions and data.

The configuration of the baseband unit 13 in the wireless transmission unit 10a and the configuration of the baseband unit 13 in the wireless reception unit 10b may be the same or different. The configuration of the RF unit 12 in the wireless transmission unit 10a and the RF unit 12 in the wireless reception unit 10b may be the same or different. The configuration of the antenna unit 11 in the wireless transmission unit 10a and the configuration of the antenna unit 11 in the wireless reception unit 10b may be the same or different.

The higher-layer processing unit 14 provides uplink data (transport blocks) to the wireless transmission and reception unit 10 (or the wireless transmission unit 10a). The higher-layer processing unit 14 may perform processing of the MAC layer, the PDCP layer, the RLC layer, and/or the RRC layer.

The MAC layer processing unit 15 in the higher-layer processing unit 14 may perform processing of the MAC layer. RRC layer processing unit 16 in the higher-layer processing unit 14 may perform the process of the RRC layer. RRC layer processing unit 16 manages various RRC parameters of the terminal device 101 based on RRC messages received from the base station device 103.

The wireless transmission and reception unit 10 (or the wireless transmission unit 10a) may perform processing, such as encoding and modulation. The wireless transmission and reception unit 10 (or the wireless transmission unit 10a) may generate a physical signal by encoding and modulating the uplink data. The wireless transmission and reception unit 10 (or the wireless transmission unit 10a) may convert OFDM symbols in the physical signal to a baseband signal by conversion to a time-continuous signal. The wireless transmission and reception unit 10 (or the wireless transmission unit 10a) may transmit the baseband signal (or the physical signal) to the base station device 103 via radio frequency. The wireless transmission and reception unit 10 (or the wireless transmission unit 10a) may arrange the baseband signal (or the physical signal) on a BWP (active uplink BWP) and transmit the baseband signal (or the physical signal) to the base station device 103.

The wireless transmission and reception unit 10 (or the wireless reception unit 10b) performs processing, such as demodulation and decoding. The wireless transmission and reception unit 10 (or the wireless reception unit 10b) may receive a physical signal in a BWP (active downlink BWP) of a serving cell. The wireless transmission and reception unit 10 (or the wireless reception unit 10b) may separate, demodulate, and decode the received physical signal, and provide the decoded information to the higher-layer processing unit 14. The wireless transmission and reception unit 10 (or the wireless reception unit 10b) may perform the channel access procedure prior to the transmission of the physical signal.

The RF unit 12 may demodulate the radio signal received via the antenna unit 11 into an analog signal, and/or removes extra frequency components. The RF unit 12 may provide the processed analog signal to the baseband unit 13. The baseband unit 13 may convert the analog signal input from RF unit 12 into a baseband signal. The baseband unit 13 may separate a portion which corresponds to CP from the baseband signal, perform FFT on the baseband signal from which the CP has been removed. The baseband unit 13 may extract components of the physical signal from the baseband signal.

The baseband unit 13 may perform IFFT on the uplink data to generate time-continuous signal, adds a CP to the generated signal, generate a baseband signal, and convert the baseband signal into an analog signal. The baseband unit 13 may provide the analog signal to the RF unit 12.

The RF unit 12 may remove extra frequency components from the analog signal input from the baseband unit 13, up-converts the analog signal to a radio frequency, and may transmit it via the antenna unit 11. RF unit 12 may have a function of controlling transmission power.

A physical signal is a generic term for physical downlink channels, physical downlink signals, physical uplink channels, and physical uplink signals. The physical channel is a generic term for physical downlink channels and physical uplink channels.

A physical uplink channel corresponds to a set of REs that carry one or both of information originating from the higher-layer and the Uplink Control Information (UCI). In the radio communication system according to one aspect of the present embodiments, a part or all of the PUCCH, PUSCH, and/or a Physical Random Access Channel (PRACH) may be used.

A PUCCH may be used to transmit the UCI. A PUCCH may be sent to deliver (transmit, convey) uplink control information. The UCI may be mapped to the PUCCH. The terminal device 101 may transmit a PUCCH in which the UCI is mapped. The base station device 103 may receive the PUCCH in which the UCI is mapped.

The Channel State Information (CSI) may be deemed as a type of UCI. The CSI is used to convey information related to the propagation path between the terminal device 101 and the base station device 103.

The Hybrid Automatic Repeat request ACKnowledgement (HARQ-ACK) information may also be deemed as a type of UCI. The HARQ-ACK information is used to convey whether the downlink data has been successfully decoded or not.

The Scheduling Request (SR) may also be deemed as a type of UCI. The SR is used to request an uplink resource (a PUSCH or a UL-SCH).

Uplink control information (uplink control information bit, uplink control information sequence, uplink control information type) includes at least part or all of the CSI, SR, and HARQ-ACK.

The CSI may include at least part or all of a channel quality indicator (CQI), a Precoder Matrix Indicator (PMI), and a Rank Indicator (RI). CQI is an indicator related to channel quality (e.g., propagation quality) or physical channel quality, and PMI is an indicator related to a precoder. RI is an indicator related to transmission rank (or the number of transmission layers).

The CSI may be provided at least based on receiving one or more physical signals (e.g., one or more CSI-RSs) used at least for channel measurement. The CSI may be selected by a terminal device at least based on receiving one or more physical signals used for channel measurement. Channel measurements may include interference measurements.

A PUSCH may be used to transmit one or both of a transport block and UCI. A PUSCH may be sent to deliver (transmit, convey) one or both of a transport block and uplink control information. The terminal device 101 may transmit a PUSCH in which one or both of a transport block and UCI is mapped. The base station device 103 may receive the PUSCH in which the one or both of the transport block and the UCI is mapped.

A PRACH may be used to transmit a random-access preamble. A PRACH may be sent to deliver (transmit, convey) an index of a random-access preamble. The terminal device 101 may transmit a PRACH. The base station device 103 may receive the PRACH.

For a given PRACH occasion, 64 random-access preambles are defined. The random-access preamble is specified (determined, given) based on the cyclic shift Cv of the PRACH and the sequence index u for the PRACH.

A physical uplink signal corresponds to a set of REs. A physical uplink signal may not carry information generated in the higher-layer. The terminal device 101 may transmit a physical uplink signal. The base station device 103 may receive the physical uplink signal. In the radio communication system according to one aspect of the present embodiment, a part or all of UpLink Demodulation Reference Signal (UL DMRS), SRS (Sounding Reference Signal (SRS), UpLink Phase Tracking Reference Signal (UL PTRS) may be used.

UL DMRS is a generic name of a DMRS for a PUSCH and a DMRS for a PUCCH. A set of antenna ports of a DMRS for a PUSCH may be given based on a set of antenna ports for the PUSCH. For example, a set of DMRS antenna ports for a PUSCH may be the same as a set of antenna ports for the PUSCH.

A PUSCH and a DMRS for the PUSCH is collectively referred to as PUSCH. A set of antenna ports of a DMRS for a PUCCH may be given based on a set of antenna ports for the PUCCH. For example, a set of DMRS antenna ports for a PUCCH may be the same as a set of antenna ports for the PUCCH. A PUCCH and a DMRS for the PUCCH is collectively referred to as PUCCH.

A physical downlink channel corresponds to a set of REs that carry one or both of information originating from the higher-layer and Downlink Control Information (DCI). In the radio communication system according to one aspect of the present embodiment, a part or all of Physical Broadcast Channel (PBCH), Physical Downlink Control Channel (PDCCH), and Physical Downlink Shared Channel (PDSCH) may be used.

A PBCH may be used to transmit a Master Information Block (MIB). A PBCH may be sent to deliver (transmit, convey) a MIB. The terminal device 101 may receive a PBCH. The base station device 103 may transmit the PBCH.

A PDCCH may be used to transmit DCI. A PDCCH may be sent to deliver (transmit, convey) DCI. The terminal device 101 may receive a PDCCH in which DCI is mapped. The base station device 103 may transmit the PDCCH in which the DCI is mapped.

The DCI format includes a set of information fields. Each information field may mask a bit sequence of the DCI. Bits masked by an information field is associated with a specific meaning associated with the information field.

Several DCI formats may be used in the radio communication system according to one aspect of the present embodiment. Several example DCI formats are provided.

DCI format 0_0 is used for scheduling a PUSCH for a cell. The DCI format 0_0 includes a part or all of Information fields 1A to 1E. Information field 1A is a DCI format identification field. Information field 1B is a Frequency Domain Resource Assignment (FDRA) field. Information field 1C is a Time Domain Resource Assignment (TDRA) field. Information field 1D is a frequency-hopping flag field. Information field 1E is a Modulation-and-Coding-Scheme (MCS) field.

A DCI format identification field may indicate whether a DCI format including the DCI format identification field is an uplink DCI format or a downlink DCI format. The DCI format identification field included in the DCI format 0_0 indicates that the DCI format 0_0 is an uplink DCI format.

A FDRA field in a DCI format may be used to indicate assignment of frequency resources for a physical channel scheduled by the DCI format. For example, the FDRA field may indicate the number of RBs, X, for PUSCH.

A TDRA field in a DCI format may be used to indicate assignment of time resources for a physical channel scheduled by the DCI format.

A frequency-hopping flag field in a DCI format may be used to indicate whether frequency-hopping is applied to a physical channel scheduled by the DCI format.

A MCS field in a DCI format may be used to indicate one or both of a modulation scheme for a physical channel scheduled by the DCI format and a target code rate for the physical channel. The target code rate is used to determine a Transport Block Size (TBS) for the physical channel.

The DCI format 0_0 may not include fields used for a CSI request. That is, CSI may not be requested by the DCI format 0_0.

The DCI format 0_0 may not include a carrier indicator field. If an uplink DCI format does not include a carrier indicator field, the terminal device 101 may determine that an uplink component carrier on which a PUSCH scheduled by the uplink DCI format is mapped is an uplink component carrier in a serving cell which includes a downlink component carrier on which a PDCCH with the uplink DCI format is mapped.

The DCI format 0_0 may not include a BWP indicator field. If a DCI format does not include a BWP indicator field, the terminal device 101 may determine that active BWP change has not been triggered by the DCI format.

DCI format 0_1 may be used for scheduling of a PUSCH for a cell. The DCI format 0_1 includes a part or all of Information fields 2A to 2H. Information field 2A is a DCI format identification field. Information field 2B is a FDRA field. Information field 2C is a TDRA field. Information field 2D is a frequency-hopping flag field. Information field 2E is an MCS field. Information field 2F is a CSI request field. Information field 2G is a BWP field. Information field 2H is a carrier indicator field.

The DCI format identification field in the DCI format 0_1 may indicate that the DCI format 0_1 is an uplink DCI format.

The CSI request field may be used to request CSI reporting.

If the DCI format 0_1 includes a BWP field, the BWP field may be used to indicate an uplink BWP on which a PUSCH scheduled by the DCI format 0_1 is mapped.

If the DCI format 0_1 includes the carrier indicator field, the carrier indicator field may be used to indicate an uplink component carrier on which a PUSCH is mapped.

DCI format 1_0 may be used for scheduling of a PDSCH for a cell. The DCI format 1_0 includes a part or all of Information fields 3A to 3F. Information field 3A is a DCI format identification field. Information field 3B is a FDRA field. Information field 3C is a TDRA field. Information field 3D is an MCS field. Information field 3E is a PDSCH-to-HARQ-feedback indicator field. Information field 3F is a PUCCH resource indicator field. The DCI format identification field in the DCI format 1_0 indicates that the DCI format 1_0 is a downlink DCI format.

The PDSCH-to-HARQ-feedback timing indicator field may be used to indicate the offset (K1) from a slot in which the last OFDM symbol of a PDSCH scheduled by the DCI format is included to another slot in which the first OFDM symbol of a PUCCH triggered by the DCI format 1_0 is mapped. The PUCCH resource indicator field may be used to indicate a PUCCH resource.

The DCI format 1_0 may not include the carrier indicator field. If a downlink DCI format does not include the carrier indicator field, the terminal device 101 may determine that a downlink component carrier on which a PDSCH scheduled by the downlink DCI format is mapped is the downlink component carrier on which the PDCCH with the DCI format 1_0 is mapped. The DCI format 1_0 may not include the BWP field.

The DCI format 1_1 may be used for scheduling of a PDSCH for a cell. The DCI format 1_1 includes a part or all of Information fields 4A to 4H. Information field 4A is a DCI format identification field. Information field 4B is a FDRA field. The 4C is a TDRA field. Information field 4D is an MCS field. Information field 4E is a PDSCH-to-HARQ-feedback indicator field. Information field 4F is a PUCCH resource indicator field. Information field 4G is a BWP field. Information field 4H is a carrier indicator field. The DCI format identification field in the DCI format 1_1 may indicate that the DCI format 1_1 is a downlink DCI format.

A PDSCH may be used to transmit a transport block. A PDSCH may be sent to deliver (transmit, convey) a transport block. The base station device 103 may transmit a PDSCH. The terminal device 101 may receive the PDSCH.

A physical downlink signal corresponds to a set of REs. A physical downlink signal may not carry the information generated in the higher-layer. The base station 103 transmits a physical downlink signal. The terminal device 101 may receive the physical downlink signal. In the radio communication system according to one aspect of the present embodiment, at least a part or all of a Synchronization signal (SS), DownLink DeModulation Reference Signal (DL DMRS), Channel State Information-Reference Signal (CSI-RS), and DownLink Phase Tracking Reference Signal (DL PTRS) may be used.

A synchronization signal may be used to synchronize in the frequency domain and time domain for downlink. The synchronization signal is a generic name of Primary Synchronization Signal (PSS) and Secondary Synchronization Signal (SSS).

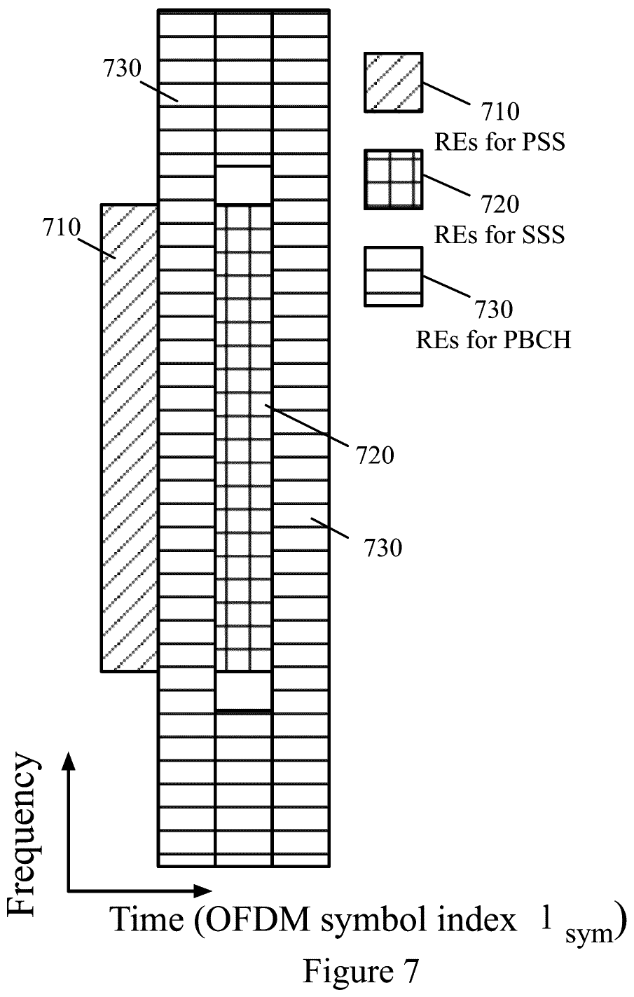

FIG. 7 is a diagram illustrating an example configuration of a synchronization signal/physical broadcast channel (SS/PBCH) block including a primary synchronization signal (PSS) and a secondary synchronization signal (SSS), according to an example implementation of the present disclosure. In FIG. 7, the horizontal axis represents the OFDM symbol index lsym, and the vertical axis represents the frequency domain. The shaded blocks 710 represent a set of REs for the PSS. The block of grid lines 720 represents a set of REs for the SSS. Also, the blocks in the horizontal line 730 represent a set of REs for the PBCH and a set of REs for a DMRS for the PBCH.

The SS/PBCH block in FIG. 7 includes a PSS, an SSS, and a PBCH. The SS/PBCH block includes 4 consecutive OFDM symbols and 240 subcarriers. The PSS is allocated to the 57th to 183rd subcarriers in the first OFDM symbol. The SSS is allocated to the 57th to 183rd subcarriers in the third OFDM symbol. The first to 56th subcarriers of the first OFDM symbol may be set to zero. The 184th to 240th subcarriers of the first OFDM symbol may be set to zero. The 49th to 56th subcarriers of the third OFDM symbol may be set to zero. The 184th to 192nd subcarriers of the third OFDM symbol may be set to zero. In the first to 240th subcarriers of the second OFDM symbol, the PBCH is allocated to subcarriers in which the DMRS for the PBCH is not allocated. In the first to 48th subcarriers of the third OFDM symbol, the PBCH is allocated to subcarriers in which the DMRS for the PBCH is not allocated. In the 193rd to 240th subcarriers of the third OFDM symbol, the PBCH is allocated to subcarriers in which the DMRS for the PBCH is not allocated. In the first to 240th subcarriers of the 4th OFDM symbol, the PBCH is allocated to subcarriers in which the DMRS for the PBCH is not allocated.

The antenna ports of the PSS, the SSS, the PBCH, and the DMRS for the PBCH in an SS/PBCH block may be identical. DL DMRS is a generic name of a DMRS for a PBCH, a DMRS for a PDSCH and a DMRS for a PDCCH.

A set of antenna ports of a DMRS for a PDSCH may be given based on a set of antenna ports for the PDSCH. For example, a set of DMRS antenna ports for a PDSCH may be the same as a set of antenna ports for the PDSCH.

A PDSCH and a DMRS for the PDSCH is collectively referred to as PDSCH. A set of antenna ports of a DMRS for a PDCCH may be given based on a set of antenna ports for the PDCCH. For example, a set of DMRS antenna ports for a PDCCH may be the same as a set of antenna ports for the PDCCH. A PDCCH and a DMRS for the PDCCH is collectively referred to as PDCCH.

A Broadcast Channel (BCH), an Uplink-Shared Channel (UL-SCH). and a Downlink-Shared Channel (DL-SCH) are transport channels. A channel used in the MAC layer is called a transport channel. A unit of transport channel used in the MAC layer is also called transport block (TB) or MAC Protocol Data Unit (MAC PDU). In the MAC layer, control of Hybrid Automatic Repeat request (HARQ) is performed for each transport block. The transport block is a unit of data delivered by the MAC layer to the physical layer. In the physical layer, transport blocks are mapped to codewords and modulation processing is performed for each codeword.

One UL-SCH and one DL-SCH may be provided for each serving cell. BCH may be given to PCell. BCH may not be given to PSCell and SCell.

A Broadcast Control Channel (BCCH), a Common Control Channel (CCCH), and a Dedicated Control Channel (DCCH) are logical channels. The BCCH is a channel of the RRC layer used to deliver MIB or system information. The CCCH may be used to transmit a common RRC message in multiple terminal devices. The DCCH may be used to transmit a dedicated RRC message to a terminal device.

The BCCH in the logical channel may be mapped to the BCH or the DL-SCH in the transport channel. The CCCH in the logical channel may be mapped to the DL-SCH or the UL-SCH in the transport channel. The DCCH in the logical channel may be mapped to the DL-SCH or the UL-SCH in the transport channel.

The UL-SCH in the transport channel may be mapped to a PUSCH in the physical channel. The DL-SCH in the transport channel may be mapped to a PDSCH in the physical channel. The BCH in the transport channel may be mapped to a PBCH in the physical channel.

A higher-layer parameter is a parameter in an RRC message or a MAC CE (Control Element). A higher-layer parameter may be a cell-specific parameter or a UE-specific parameter. A cell-specific parameter is a parameter including a common configuration in a cell. A UE-specific parameter is a parameter including a configuration that may be configured differently for each UE.

The BS 103 may indicate change of cell-specific parameters by reconfiguration with random-access. The BS 103 may indicate change of UE-specific parameters by reconfiguration with or without random-access.

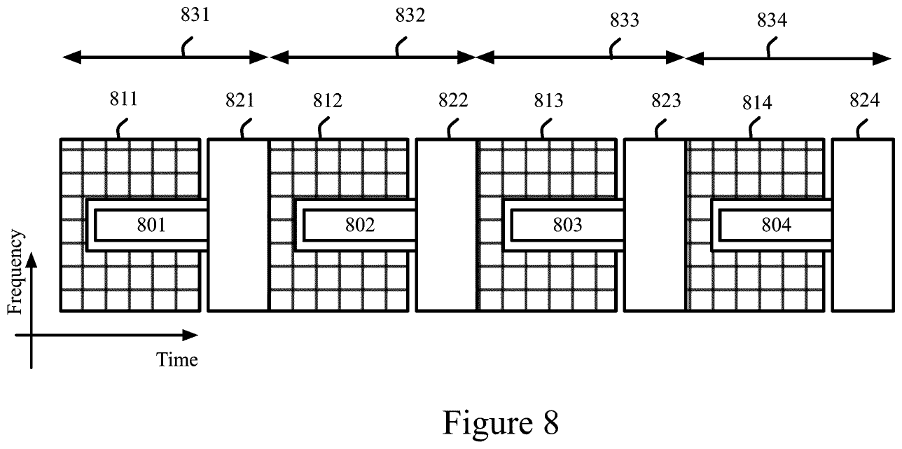

FIG. 8 is a time-frequency diagram illustrating an example resource partitioning in a serving cell, according to an example implementation of the present disclosure. The horizontal axis represents the time domain. The vertical axis represents the frequency domain. The regions 801, 802, 803, and 804 represent the time-frequency resources for a UL subband. The regions 811, 812, 813, and 814 with grid lines represent DL regions. The regions 821, 822, 823, and 824 represent UL regions. The lines 831, 832, 833, and 834 represent periods of the time division duplexing (TDD) pattern. Each region represents a resource for each SS/PBCH block with a different index. Time domain guard periods are placed on a switching location from DL to UL. Frequency domain guard bands are placed on a boundary of DL and UL.

TDD pattern is a pattern including a part of all the DL region, flexible region, and UL region. In FIG. 8, the TDD pattern includes the DL region and the UL region. The time domain guard period between the DL region and UL region may be as part of the DL region, as part of the UL region, or flexible region. The TDD pattern may be configured based on one or more RRC parameters provided by the RRC layer.

The UL subband may be configured in one or both of the DL region and the time domain guard period. The time domain resource of the UL subband may be configured by one or more RRC parameters provided by the RRC layer.

The time domain resource of the UL subband may be configured by one or more first RRC parameters used to indicate a periodicity of the UL subband, one or more second RRC parameters used to indicate the starting slot of the UL subband in each period, and one or more third RRC parameters used to indicate the length of the UL subband in each period in number of slots. For example, in a case that the periodicity is 20 slots, the starting slot is the 3rd slot, and the length is 11 slots, the terminal device 101 determines that the UL subband with length of 11 slots starting at the 3rd slot is placed in each periodicity.

One or more first RRC parameters used to indicate the periodicity may be one or more RRC parameters different from the one or more RRC parameters used to indicate the periodicity of the TDD pattern. For example, the one or more RRC parameters used to indicate the periodicity of the TDD pattern may be reused to indicate the periodicity of the UL subband. For example, the terminal device 101 may assume the periodicity of the UL subband is the same as the periodicity of the TDD pattern.

One or more fourth RRC parameters may be used to indicate the starting OFDM symbol of the UL subband in the starting slot. For example, one or more fifth RRC parameters may be used to indicate the length of the UL subband in number of symbols. For example, the frequency domain resource of the UL subband may be configured by one or more first RRC parameters used to indicate the starting RB of the UL subband and one or more second RRC parameters used to indicate the length of the UL subband in number of RBs.

The UL subband may be configured in an SCS-specific carrier. Therefore, in this case, the RRC parameters used to indicate resources of the UL subband may be provided per SCS-specific carrier. The UL subband may be configured in a BWP. Therefore, in this case, the RRC parameters used to indicate resources of the UL subband may be provided per BWP.

Using the UL subband, the base station device 103 may perform simultaneous transmission and reception at a time. For example, in a time occasion with UL subband 801, the base station device 103 performs transmission of physical downlink channels in the region 811 and reception of physical uplink channels in the region 801 at a time. The time occasion where the UL subband is mapped is referred to as a SubBand Full Duplex (SBFD) region.

Various physical layer configurations may be independently provided for the SBFD region and non-SBFD region. For example, the base station device 103 may use different QCL properties for the SBFD region and the non-SBFD region. The base station device 103 may use different settings for the components of the RF unit 32. For example, the components may include analog filters, amplifiers, or clocks. The terminal device 101 may obtain information related to the various physical layer configurations from the base station device 103.

### Allocating Resource Block Groups and Precoding Resource Groups for PDSCH

Frequency domain guard bands may be configured in an SCS-specific carrier. For example, one or more RRC parameters that indicate resources of the frequency domain guard bands may be provided by the BS per SCS-specific carrier.

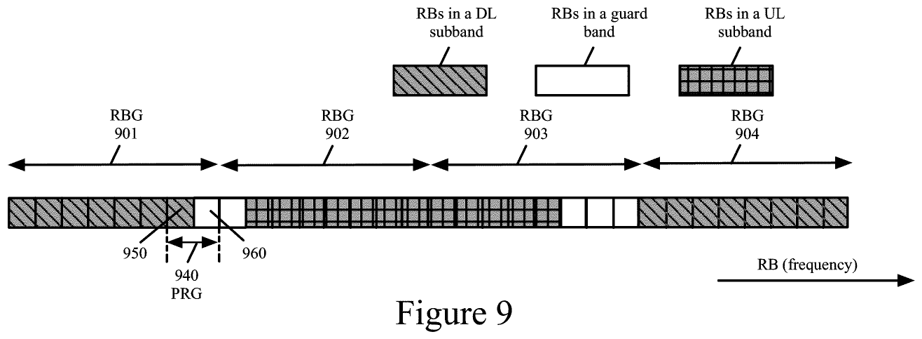

FIG. 9 is a diagram illustrating an example SBFD configuration in frequency domain, according to an aspect of the present embodiment. In FIG. 9, each block represents an RB. The RBs may include RBs in a DL subband, RBs in a frequency domain guard band, and RBs in an UL subband.

In some implementations, the frequency domain resource assignment of a PDSCH may be derived from a FDRA field in a DCI format for scheduling the PDSCH. The FDRA field may include a bitmap. Each bit in the bitmap may be associated with a Resource Block Group (RBG). For example, in a case that a bit in the bitmap is set to ‘1’, the UE may assume that the associated RBG is allocated for the PDSCH.

In FIG. 9, each RBG 901-904 includes eight continuous RBs. In an SBFD region, RBs in the frequency domain guard bands or in the UL subband may not be available for a PDSCH. Therefore, in the example of FIG. 9, the RBG 902 and the RBG 903 may not be available for a PDSCH. On the other hand, the RBG 904 and a part of the RBG 901 may be available for a PDSCH.

However, every RB in RBG 901 may not be available for a PDSCH. Therefore, in a case that the UE receives a DCI format indicating an RBG is allocated for a PDSCH, the UE may assume that RBs in the DL subband of the RBG are allocated for the PUSCH and the RBs outside the DL subband are not allocated.

Some implementations may further configure Precoding Resource Groups (PRGs). A PRG is a group of RBs in which the UE may assume that the same precoding has been applied to all RBs in the group. That may lead to better channel estimation accuracy using a channel estimator for the group of RBs, compared to a channel estimator for each RB.

In a case that PRGs with two RB granularity are configured, a PRG may be configured that may overlap with the DL subband and the frequency domain guard band. For example, as shown in FIG. 9, the PRG 940 may include the RB 950 in the DL subband and the RB 960 in the frequency domain guard band. In this case, allocating the RB 950 for a PDSCH and not allocating the RB 960 may not be beneficial. It may complicate the channel estimator.

It should be noted that the BS may not configure guard bands in an SBFD region. In a case that no guard bands are configured in the SBFD region and PRGs with two RB granularity are configured, a PRG may be configured that may include an RB in the DL subband and an RB in the UL subband.

In some embodiments, the UE may assume that in a case that at least one RB in a PRG is outside the DL subband (e.g., either in the UL subband or in the frequency domain guard band), no RBs in the PRG may be allocated for a PDSCH. Furthermore, the UE may assume that the RBs in a PRG are allocated for the PSCH in a case that all the RBs in the PRG are in the DL subband.

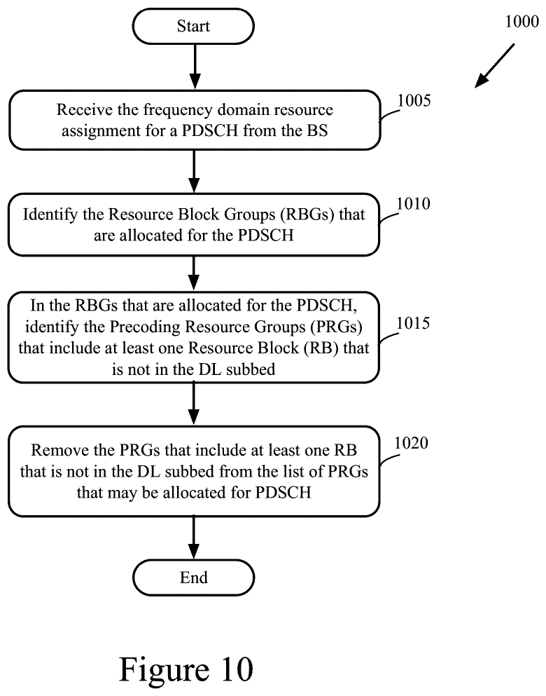

FIG. 10 is a flowchart illustrating an example method/process 1000 performed by a terminal device for allocating the PRGs for PDSCH, according to an example implementation of the present disclosure. With reference to FIG. 10, the process 1000 may be performed by at least one processor of any of the wireless terminals 101A-101C, shown in FIG. 1.

The process 1000 may receive (at block 1005) the frequency domain resource assignment for a PDSCH for the BS. For example, the BS may include the PDSCH frequency domain resource assignment in a FDRA field in a DCI format. As described above with reference to FIG. 9, the FDRA field may include a bitmap, and each bit in the bitmap may be associated with an RBG that may indicate whether or not the associated RBG is allocated for the PDSCH.

The process 1000 may identify (at block 1010) the RBGs that are allocated for the PDSCH. For example, the process 1000 may use the bitmap in the FDRA field to identify the RBGs that are allocated for the PDSCH. For example, the process 1000 may identify the RBGs 901 and 904, shown in FIG. 9, as the RBGs that are allocated by the BS for the PDSCH.

In the RBGs that are allocated for the PDSCH, the process 1000 may identify (at block 1015) the PRGs that include at least one RB that is not in the DL subband. For example, the process 1000 may identify the PRG 940 shown in FIG. 9 as a PRG that is allocated for the PDSCH that has at least one RB (e.g., RB 960) that is not in the DL subband.

The process 1000 may remove (at block 1020) the PRGs that include at least one RB that is not in the DL subband from the list of PRGs that may be allocated for PDSCH. For example, the process 1000 may mark the PRG 940 as a PRG that is not available for the PDSCH. The process 1000 may then end.

### Selecting a PRACH Resource Configuration by the Terminal Device

In some embodiments, a terminal device may configure PRACH occasions in the UL subband. To configure PRACH occasions in the UL subband, the BS may provide a first PRACH resource configuration and a second PRACH resource configuration to the UE. The first PRACH resource configuration may be a PRACH resource configuration shared by non-SBFD aware UEs and SBFD aware UEs. The second PRACH resource configuration may be a PRACH resource configuration that is not visible to the non-SBFD aware UEs.

The SBFD aware UEs are the UEs that know the time and frequency locations of subbands. The SBFD aware UEs may be provided the UL subband configurations. The non-SBFD aware UEs may not be provided the UL subband configurations.

A PRACH resource configuration may be provided via one or more RRC parameters. For example, one or more RRC parameters may be included in an RRC layer information element RACH-ConfigCommon. The RRC parameters may include one or more of the following information: (1) information regarding the format of the PRACH, (2) information regarding time and/or frequency domain resources of the PRACH, and (3) information regarding the number of random-access preambles available for random-access per PRACH occasion.

The information regarding the format of the PRACH may be used to determine one or more of the length of the PRACH, the number of subcarriers for the PRACH, and the number of sequence repetitions in the PRACH.

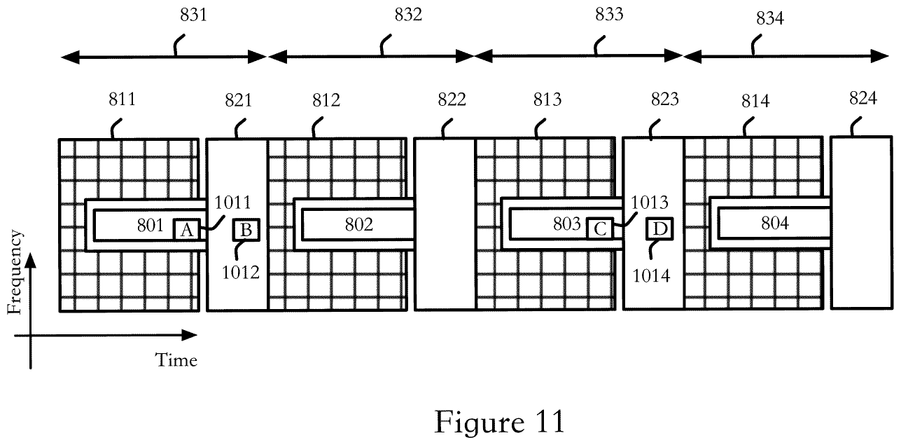

FIG. 11 is a time-frequency diagram illustrating an example configuration of the PRACH occasions, according to an aspect of the present embodiment. In FIG. 11, the regions A 1101, B 1102, C 1103, and D 1104 represent the PRACH occasion in one PRACH resource configuration. Other components of FIG. 11 may be similar to the corresponding components of FIG. 8.

From a PRACH resource configuration, multiple PRACH occasions may be derived using the information regarding the time and/or frequency domain resources of the PRACH. In FIG. 11, the PRACH occasions are mapped twice per TDD pattern periods 831-833.

In a case that PRACH occasions are deployed based on the information regarding the time and/or frequency domain resources of the PRACH, the UE may validate some PRACH occasions based on the TDD pattern. The TDD pattern may be the pattern provided by an RRC parameter included in the common RRC message.

In some embodiments, the UE may validate a PRACH occasion if the PRACH occasion is fully covered by the UL regions or flexible regions. The UE may not validate a PRACH occasion if the PRACH occasion is not fully covered by the UL regions or flexible regions.

In some embodiments, the UE may not validate a PRACH occasion if at least a part of the PRACH occasion is covered by the DL regions. The UE may validate a PRACH occasion if none of the PRACH occasion is covered by the DL regions.

In FIG. 11, the PRACH occasions B 1102 and D 1104 are validated. The PRACH occasions A 1101 and C 1103 are not validated. It should be noted that according to the existing 3PP specification, validation check may be done only based on the common TDD configuration. For example, according to the existing 3GPP standard, irrespective of the UL subbands 801 and 803, the PRACH occasions A 1011 and C 1013 may be invalidated based on the TDD configuration. However, as described below, configuring the PRACH occasions based on PRACH resource configuration may allow using the PRACH occasions that are in the UL subbands.

As described below, the SBFD aware UEs may use different criteria to select either the first PRACH resource configuration or the second PRACH resource configuration. A SBFD aware UE, in some embodiments, may select one of the PRACH resource configurations based on an indication received from the BS. A SBFD aware UE, in some embodiments, may select one of the PRACH resource configurations based on comparing a reception quality value with a Reference Signal Reception Power (RSRP) threshold. A SBFD aware UE, in some embodiments, may always use the second PRACH resource configuration.

In a random access mode, such as Contention-Free Random-Access (CFRA), the BS may provide the UE with an instruction. For example, in a CFRA triggered by a PDCCH order, a DCI format may be used by the BS to indicate the instruction. The instruction may include one or more of a PRACH resource configuration instruction, a PRACH occasion instruction, and a random-access preamble instruction.

The PRACH resource configuration instruction may be used by the UE to determine which PRACH resource configuration to select form the first and second PRACH resource configurations. In some embodiments, the PRACH resource configuration instruction may be a DCI field in the DCI format. The DCI field may, for example, be a 1-bit field. The 1-bit DCI field may indicate which PRACH resource configuration to be selected from the first and second PRACH resource configurations.

In some embodiments, the PRACH resource configuration instruction may be conveyed via the PRACH mask index field. In these embodiments, one or more reserved code points in the PRACH mask index may be used to determine the PRACH resource configuration.

In some embodiments, the PRACH resource configuration instruction may be indicated via the random-access preamble index field. In these embodiments, one or more reserved code points in the PRACH mask index may be used to determine the PRACH resource configuration.

In some embodiments, one or more reserved bits in the DCI format may be used to define a dedicated field to indicate a PRACH resource configuration. In a case that multiple PRACH resource configurations are provided, one of the multiple PRACH resource configurations may be indicated by the dedicated field.

The PRACH occasion instruction may be used to select a PRACH occasion from multiple validated PRACH occasions in the determined PRACH resource configuration. For example, in FIG. 11, the PRACH occasion instruction may be used to select a PRACH occasion from the PRACH occasions B and D. The PRACH occasion instruction may be encoded in a PRACH mask index field in the DCI format.

The random-access preamble instruction may be used to select a random-access preamble from the random-access preambles available for the PRACH in the selected PRACH occasion. The random-access preamble instruction may be encoded in a random-access preamble index field in the DCI format.

Alternatively, the UE may select one of the PRACH resource configurations based on a reception quality value that is measured by the UE. For example, the reception quality value may be the RSRP of the SS/PBCH block that is currently monitored by the UE. The UE may compare the reception quality value with a threshold. Based on the comparison, the UE may select one of the first and second PRACH resource configurations. For example, if the reception quality value is larger than the threshold, the UE may select the first PRACH resource configuration. If the reception quality value is smaller than the threshold, the UE may select the second PRACH resource configuration. If the reception quality value is equal to the threshold, the UE may select either one of the first or second PRACH resource configurations. The threshold, in some embodiments may be provided by an RRC parameter.

In some embodiments, the UE may assume that the second PRACH resource configuration is used for the CFRA. Alternatively, the UE may be provided the PRACH resource configuration instruction of the PRACH resource configuration to use for the CFRA via an RRC parameter.

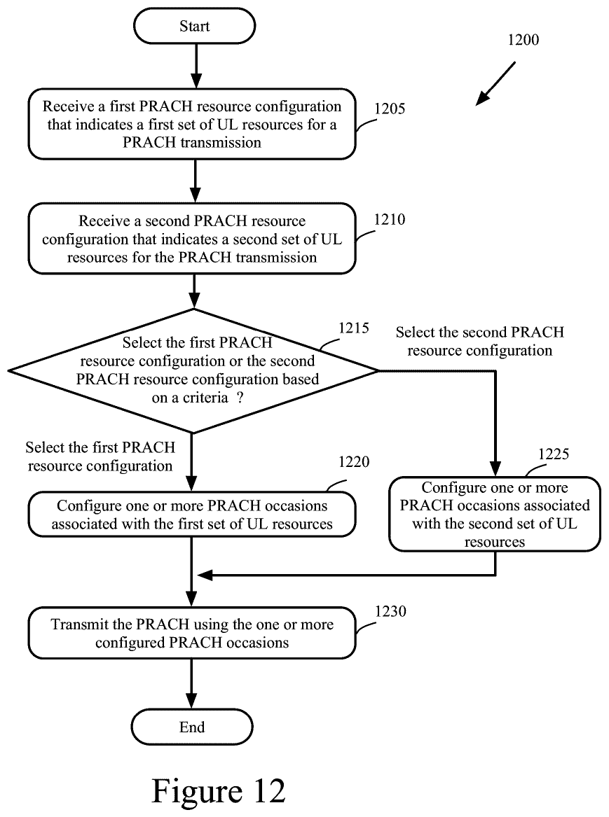

FIG. 12 is a flowchart illustrating an example method/process 1200 performed by a terminal device to transmit a PRACH, according to an example implementation of the present disclosure. With reference to FIG. 12, the process 1200 may be performed by at least one processor of any of the wireless terminals 101A-101C, shown in FIG. 1.

The process 1200 may receive (at block 1205) a first PRACH resource configuration that may indicate a first set of UL resources for a PRACH transmission. For example, the first set of UL resources may include one or more non-SBFD UL resources. The first PRACH resource configuration may be shared by SBFD aware UEs and non-SBFD aware UEs.

The process 1200 may receive (at block 1210) a second PRACH resource configuration that indicates a second set of UL resources for a PRACH transmission. For example, the second set of UL resources may include one or more SBFD UL resources. The second PRACH resource configuration may not be available to the non-SBFD aware UEs.

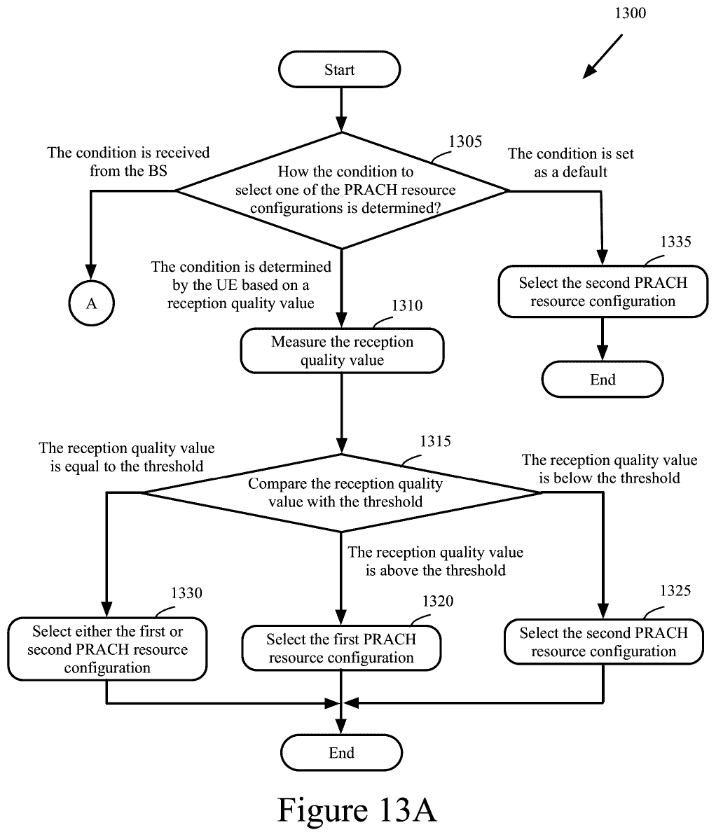

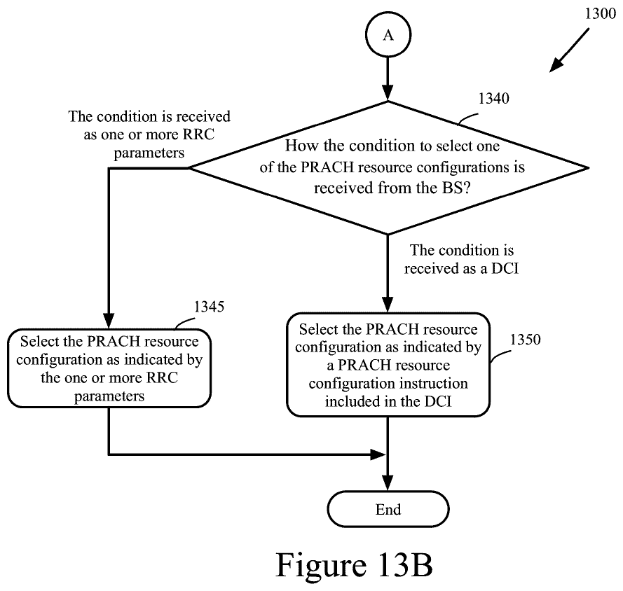

The process 1200 may determine (at block 1215) whether to select the first PRACH resource configuration or the second PRACH resource configuration based on a criteria. Details of the block 1215 of the process 1200 are described below with reference to FIGS. 13A-13B.

The process 1200 may configure (at block 1220) one or more PRACH occasions associated with the first set of UL resources in a case that the first PRACH resource configuration is selected. The process 1200 may then proceed to block 1230, which is described below.

The process 1200 may configure (at block 1225) one or more PRACH occasions associated with the second set of UL resources in a case that the second PRACH resource configuration is selected. At block 1230, the process 1200 may transmit the PRACH using the one or more configured PRACH occasions. The process 1200 may then end.

FIGS. 13A-13B illustrate a flowchart of an example method/process 1300 performed by a terminal device to select a PRACH resource configuration based on a criteria, according to an example implementation of the present disclosure. The process 1300 provides details for block 1215 of FIG. 12.

With reference to FIGS. 13A-13B, the process 1300 may decide (at block 1305) how the condition to select one of the PRACH resource configurations is determined. In a case that the condition is received from the BS, the process 1300 proceeds to block 1340, which is described below. In a case that the condition is set as default, the process 1300 may proceed to block 1335, which is described below.

In a case that the condition is determined by the UE based on a reception quality value, the process 1300 measure (at block 1310) the reception quality value. In some embodiments, the reception quality value may be an RSRP of a SS/PBCH block that is currently monitored by the UE.

The process 1300 may compare (at block 1315) the reception quality value with a threshold. In some embodiments, the threshold may be received from the BS as an RRC parameter. In a case that the reception quality value is above the threshold, the process 1300 may select (at block 1320) the first PRACH resource configuration. The process 1300 may then end.

In a case that the reception quality value is below the threshold, the process 1300 may select (at block 1320) the second PRACH resource configuration. The process 1300 may then end. In a case that the reception quality value is equal to the threshold, the process 1300 may select either one of the first or second PRACH resource configurations. The process 1300 may then end.

In a case that the process 1300 decides (at block 1305) that the condition to select one of the PRACH resource configurations is set as a default, the process 1300 may select (at block 1335) the second PRACH resource configuration. For example, the BS may select the second resource configuration in a case that the BS uses a CFRA procedure. The process 1300 may then end.

In a case that the process 1300 decides (at block 1305) that the condition to select one of the PRACH resource configurations is received from the BS, the process 1300 may determine (at block 1340) how the condition to select one of the PRACH resource configurations is received from the BS. In a case that the process 1300 determines (at block 1340) that the condition is received as one or more RRC parameters, the process 1300 may select (at block 1345) the PRACH resource configuration as indicated by the one or more RRC parameters. In some embodiments, the one or more RRC parameters may be included by the BS in an RRC layer information element RACH-ConfigCommon. The process 1300 may then end.

The one or more RRC parameters may include information regarding the format of the PRACH, information regarding time domain resources of the PRACH, information regarding frequency domain resources of the PRACH, and information regarding the number of random-access preambles available for random-access per each PRACH occasion. For example, the information regarding the format of the PRACH may be used to determine one or more of the length of the PRACH, the number of subcarriers for the PRACH, and the number of sequence repetitions in the PRACH.

In a case that the process 1300 determines (at block 1340) that the condition is received as a DCI, the process 1300 may select (at block 1350) a PRACH resource configuration as indicated by a PRACH resource configuration instruction included in the DCI. The process 1300 may then end.

In some embodiments, the DCI may further include a PRACH occasion instruction. The UE may use the PRACH occasion instruction to validate several of the PRACH occasions. The UE may select a PRACH occasion from the plurality of PRACH occasions to transmit the PRACH. In some embodiments, the DCI further includes a random-access preamble instruction, which may be used by the UE to select a random-access preamble from several random-access preambles that are available for the PRACH in the selected PRACH occasion.

The various foregoing example embodiments and modes may be utilized in conjunction with one another, e.g., in combination with one another.

Each of a program running on the BS 103 and the terminal device 101A-101C according to an aspect of the present invention may be a program that controls a Central Processing Unit (CPU) and the like, such that the program causes a computer to operate in such a manner as to realize the functions of the above-described embodiment according to the present invention. The information handled in these devices is transitorily stored in a Random-Access-Memory (RAM) while being processed. Thereafter, the information is stored in various types of Read-Only-Memory (ROM) such as a Flash ROM and a Hard-Disk-Drive (HDD), and when necessary, is read by the CPU to be modified or rewritten.

Note that the terminal device 101A-101C and the BS 103 according to the above-described embodiment may be partially achieved by a computer. In this case, this configuration may be realized by recording a program for realizing such control functions on a computer-readable recording medium and causing a computer system to read the program recorded on the recording medium for execution.

Note that it is assumed that the “computer system” mentioned here refers to a computer system built into the terminal device 101A-101C or the BS 103, and the computer system includes an OS and hardware components such as a peripheral device. Furthermore, the “computer-readable recording medium” refers to a portable medium such as a flexible disk, a magneto-optical disk, a ROM, a CD-ROM, and the like, and a storage device built into the computer system such as a hard disk.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, the BS 103 according to the above-described embodiment may be achieved as an aggregation (a device group) including multiple devices. Each of the devices configuring such a device group may include some or all of the functions or the functional blocks of the BS 103 according to the above-described embodiment. The device group may include each general function or each functional block of the BS 103. Furthermore, the terminal device 101A-101C according to the above-described embodiment can also communicate with the base station device as the aggregation.

Furthermore, the BS 103 according to the above-described embodiment may serve as an Evolved Universal Terrestrial Radio Access Network (E-UTRAN) and/or NG-RAN (Next Gen RAN, NR-RAN). Furthermore, the BS 103 according to the above-described embodiment may have some or all of the functions of a node higher than an eNodeB or the gNB.

Furthermore, some or all portions of each of the terminal device 101A-101C and the base station device 103 according to the above-described embodiment may be typically achieved as an LSI which is an integrated circuit or may be achieved as a chip set. The functional blocks of each of the terminal device 101A-101C and the BS 103 may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case that with advances in semiconductor technology, a circuit integration technology with which an LSI is replaced appears, it is also possible to use an integrated circuit based on the technology.

Furthermore, according to the above-described embodiment, the terminal device 101A-101C has been described as an example of a communication device, but the present invention is not limited to such a terminal device, and is applicable to a terminal device or a communication device of a fixed-type or a stationary-type electronic device installed indoors or outdoors, for example, such as an Audio-Video (AV) device, a kitchen device, a cleaning or washing machine, an air-conditioning device, office equipment, a vending machine, and other household devices.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

What is claimed is:

1. A user equipment (UE), comprising:
one or more non-transitory computer-readable media storing one or more computer-executable instructions for transmitting a Physical Random Access Channel (PRACH); and
at least one processor coupled to the one or more non-transitory computer-readable media, and configured to execute the one or more computer-executable instructions to cause the UE to:
receive a first PRACH resource configuration that indicates a first set of uplink (UL) resources for a PRACH transmission;
receive a second PRACH resource configuration that indicates a second set of UL resources for the PRACH transmission;
determine whether to select the first PRACH resource configuration or the second PRACH resource configuration based on a criteria;
configure one or more PRACH occasions associated with the first set of UL resources in a case that the first PRACH resource configuration is selected;
configure one or more PRACH occasions associated with the second set of UL resources in a case that the second PRACH resource configuration is selected; and
transmit the PRACH using the one or more PRACH occasions.

2. The UE of claim 1, wherein the first set of UL resources comprises one or more non-SubBand Full Duplex (non-SBFD) UL resources, and the second set of UL resources comprises one or more SBFD UL resources.

3. The UE of claim 1, wherein the at least one processor is further configured to execute the one or more computer-executable instructions to cause the UE to:
measure a reception quality value by the UE,
wherein determining whether to select the first PRACH resource configuration or the second PRACH configuration based on a criteria comprises:
selecting the first PRACH resource configuration in a case that the reception quality value is above a threshold;
selecting the second PRACH resource configuration in a case that the reception quality value is below the threshold; and
selecting either one of the first and second PRACH resource configurations in a case that the reception quality value is equal to the threshold.

4. The UE of claim 3, wherein the reception quality value is a Reference Signal Reception Power (RSRP) of a synchronization signal/physical broadcast channel (SS/PBCH) block currently monitored by the UE.

5. The UE of claim 3, wherein the at least one processor is further configured to execute the one or more computer-executable instructions to cause the UE to:
receive the threshold from the BS as a radio resource control (RRC) parameter.

6. The UE of claim 1, wherein the at least one processor is further configured to execute the one or more computer-executable instructions to cause the UE to:
receive one or more RRC parameters from the BS in a radio resource control (RRC) message,
wherein determining whether to select the first PRACH resource configuration or the second PRACH configuration based on a criteria comprises determining the PRACH resource configuration based on the RRC parameters.

7. The UE of claim 6, wherein the one or more RRC parameters are included by the BS in an RRC layer information element RACH-ConfigCommon.

8. The UE of claim 6, wherein the one or more RRC parameters comprise one or more of:
information regarding a format of the PRACH,
information regarding time domain resources of the PRACH,
information regarding frequency domain resources of the PRACH, and
information regarding a number of random-access preambles available for random-access per each PRACH occasion.

9. The UE of claim 8, wherein the at least one processor is further configured to execute the one or more computer-executable instructions to cause the UE to:
determine one or more of a length of the PRACH, a number of subcarriers for the PRACH, and a number of sequence repetitions in the PRACH based on the information regarding the format of the PRACH.

10. The UE of claim 1, wherein the at least one processor is further configured to execute the one or more computer-executable instructions to cause the UE to:
receive a downlink control information (DCI) from the BS,
wherein determining whether to select the first PRACH resource configuration or the second PRACH configuration based on a criteria comprises:
selecting the PRACH resource configurations based on a PRACH resource configuration instruction included in the DCI.

11. The UE of claim 9, wherein
the DCI further comprises a PRACH occasion instruction,
the at least one processor is further configured to execute the one or more computer-executable instructions to cause the UE to:
validate a plurality of PRACH occasions; and
select a PRACH occasion from the plurality of PRACH occasions to transmit the PRACH.

12. The UE of claim 11, wherein the DCI further comprises a random-access preamble instruction,
wherein the at least one processor is further configured to execute the one or more computer-executable instructions to cause the UE to:
select a random-access preamble from a plurality of random-access preambles available for the PRACH in the selected PRACH occasion.

13. The UE of claim 1, wherein selecting one of a first or second PRACH resource configurations based on a criteria comprises:
determining whether a Contention-Free Random-Access (CFRA) procedure is used by the BS; and
selecting the second PRACH resource configuration in a case that the CFRA procedure is used.

14. The UE of claim 1, wherein:
the UE is a SubBand Full Duplex (SBFD) aware UE,
the first PRACH resource configuration is shared by SBFD aware UEs and non-SBFD aware UEs, and
the second PRACH resource configuration is not available to the non-SBF aware UEs.

15. A method of transmitting a Physical Random Access Channel (PRACH), the method comprising:
receiving a first PRACH resource configuration that indicates a first set of uplink (UL) resources for a PRACH transmission;
receiving a second PRACH resource configuration that indicates a second set of UL resources for the PRACH transmission;
determining whether to select the first PRACH resource configuration or the second PRACH resource configuration based on a criteria;
configuring one or more PRACH occasions associated with the first set of UL resources in a case that the first PRACH resource configuration is selected;
configuring one or more PRACH occasions associated with the second set of UL resources in a case that the second PRACH resource configuration is selected; and
transmitting the PRACH using the one or more PRACH occasions.
